(19) United States
(12) Patent Application Publication
(10) Pub. No.: US 2016/0038848 A1
(43) Pub. Date: Feb. 11, 2016

(54) Speech remote control device

(71) Applicant: TOPRAY MEMS INC., Hsinchu City (TW)

(72) Inventors: Yi-Jung CHEN, Hsinchu City (TW); Chin-Sung LIU, Hsinchu City (TW); Ping-Ju CHANG, Hsinchu City (TW)

(73) Assignee: TOPRAY MEMS INC., Hsinchu City (TW)

(21) Appl. No.: 14/455,186

(22) Filed: Aug. 8, 2014

(51) Int. Cl. A63H 30/02; G10L 15/065; G10L 21/16; G10L 15/22

(52) U.S. Cl. CPC A63H 30/02; G10L 15/22; G10L 15/065; G10L 21/16; G10L 2015/223

(57) ABSTRACT

A speech remote control device includes a speech input unit, a speech identification unit, a motion setting unit, a transmit unit and a receiving unit. The speech input unit converts a received speech command into a speech signal, and transmits the speech signal. The speech identification unit receives the speech signal, generates and transmits an encoded message corresponding to the received speech signal. The motion setting unit receives and decodes the encoded message into a control message, which comprises a proceeding command, and is further transferred to the transmit unit. The transmit unit receives the proceeding command and transfers the received proceeding command to the receiving unit, which drives a remote control car to perform a proceeding motion corresponding to the proceeding command. The remote control car can perform a continuous proceeding motion or a stream of proceeding motions so as to simulate the motion of a real car.

### BACKGROUND OF THE INVENTION

1. Field of the Invention

The present invention generally relates to a speech remote control device, and more specifically to a speech remote control device using speech to control a remote control car to perform a stream of operations or traveling motions or simulate various motions of a car.

2. The Prior Arts

In general, it is believed that a remote control car is one of the most popular interactive model toys for adults and kids. A traditional remote control car is controlled remotely by manipulating the joystick, or bar or the keys provided on the remote controller so as to cause the remote control car to perform corresponding motions like moving forward or backward, or turning around.

The control system in the prior arts, the function of controlling the remote control car can be implemented by broadcasting technology like frequency modulation (FM) or amplitude modulation (AM). A remote control car basically comprises a car body, a signal receiving unit and a drive part. Specifically, the signal receiving unit and the drive part are provided in the car body, and electrically connected to each other. When the user sends an operation signal, the signal receiving unit receives and converts the operation signal into an operation command, and the drive part drives the car body to move based on the operation command.

The control direction of the current remote control car is oriented by the head of the remote control car. As a result, it often happens that the proceeding direction of the remote control car is opposite to the direction in which the joystick or bar is pulled by the user during remote control. This problem may cause the remote control car to bump into or get stuck in the obstacle on the way, or even suffer from serious damage.

Poor sensitivity of the joystick and the keys for the user is another drawback. The hardware is actuated and the operation signal is then triggered and transferred to the drive part to move the remote control car. In addition, the user needs to correctly pull or move the joystick/bar or press the keys so as to generate the operation signal, thereby leading to a time delay issue. In other words, it takes some time for the hardware to operate and process the signal. The remote control car possibly fails to move or stop immediately. Hence, the remote control car may easily overturn, collide with an undesired object or get stuck in an obstacle.

The traditional gun-like or joystick controller is provided with an actuating control mechanism for controlling the turning motion and the petrol throttle bar of the remote control car. With the joystick controller, the throttle bar can be manipulated to move upward, downward and turning the throttle bar in the leftwise and rightwise directions so as to cause the remote control car to move forward or backward, stopping, turning and running around. As stated above, movement of the joystick causes delay response action and hence can not result in immediate action of the remote control car. Hence, the remote control car fails to perform continuous motions or simulate a real car's actual motions.

For example, during the road driving examination, the remote control car is required to travel in S direction. But, the currently available remote control car is unable to travel in the S direction, because for the remote control car to travel in the S direction, the operator must first of all manipulate the joystick to the right direction and immediately moves the joystick in an arc route substantially leftwise until the remote control car generally finishes one half of the S turn and then the joystick is turned to the right direction and immediately moves in an arc route substantially rightwise until the remote control car reaches the designated position, thereby finishing another half of the S turn. However, when the operator r pulls the joystick to left from right and vice versa, the remote control car does not respond immediately, thereby leading to a zigzag route rather than the S turn.

Obviously, it is difficult for the remote control car to simulate the motions of the real car. Not only the player loses his interest in playing the remote control car in a short period of time, but also the function and application of the remote control car are extremely limited.

Therefore, it is greatly needed to develop a new remote control design with the feature of real time control so as to cause the remote control car to perform a continuous proceeding motion or a stream of continuous proceeding motions, or further simulate various motions of a real car.

### SUMMARY OF THE INVENTION

The primary object of the present invention is to provide a speech remote control device for real time controlling the remote control car to perform a continuous proceeding motion or a stream of continuous proceeding motions.

To achieve the above object, the speech remote control device of the present invention generally comprises a speech input unit, a speech identification unit, a motion setting unit, a transmit unit and a receiving unit. Specifically, the speech input unit is provided in the speech remote control device for receiving a speech command, converting the speech command into a speech signal, and transferring the speech signal.

The speech identification unit is provided in the speech remote control device and connected to the speech input unit for receiving the speech signal. An encoded message corresponding to the speech signal is generated and transmitted. The speech identification unit is built-in with a programmable and rewritable speech identification database comprising a plurality of encoded messages, which are preset and correspond to the plurality of speech signals, respectively. When one of the speech messages preset in the speech identification database is identified by the speech identification unit, the corresponding encoded message is generated and transmitted.

The motion setting unit is provided in the speech remote control device and connected to the speech identification unit for receiving the encoded message, decoding the encoded message into a control message, and transmitting the control message. The motion setting unit is built-in with a programmable and rewritable motion setting database comprising a plurality of control messages, which are preset in such a manner to correspond with the plurality of encoded messages, respectively. More specifically, the control message at least comprises a proceeding command.

The transmit unit is provided in the speech remote control device and connected to the motion setting unit for receiving the proceeding command, and transmitting the received proceeding command, and the receiving unit is provided in the remote control car for receiving the proceeding command to drive the remote control car to execute the proceeding command and perform a corresponding proceeding motion.

With this, the user can directly give a speech command like talking to cause the remote control car to perform the motion corresponding to the speech command, and the time taken by the user pulling control bar and the control bar triggering the control signal is further saved in comparison with the hand-controlled remote device in the prior arts. Thus, after the user sends the speech command, the remote control car can immediately perform the corresponding motion so as to fulfill the object of real time remote control.

As long as the user gives one speech command (like S turn), the remote control car is manipulated to perform a continuous motion or a stream of continuous motions such that the effect of variety for remote control is produced, more precise control is implemented, the function is enhanced and the application field is expanded.

The present invention further provides the entertaining function of displaying music and the effect of vibration feedback, thereby greatly improving the fun of playing the remote control car.

### BRIEF DESCRIPTION OF THE DRAWINGS

The present invention can be understood in more detail by reading the subsequent detailed description in conjunction with the examples and references made to the accompanying drawings, wherein:

FIG. 1 is a functional block diagram of the speech remote control device according to a first embodiment of the present invention; and

FIG. 2 is a functional block diagram of the speech remote control device according to a second embodiment of the present invention.

### DETAILED DESCRIPTION OF THE PREFERRED EMBODIMENT

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within the spirit of the present invention.

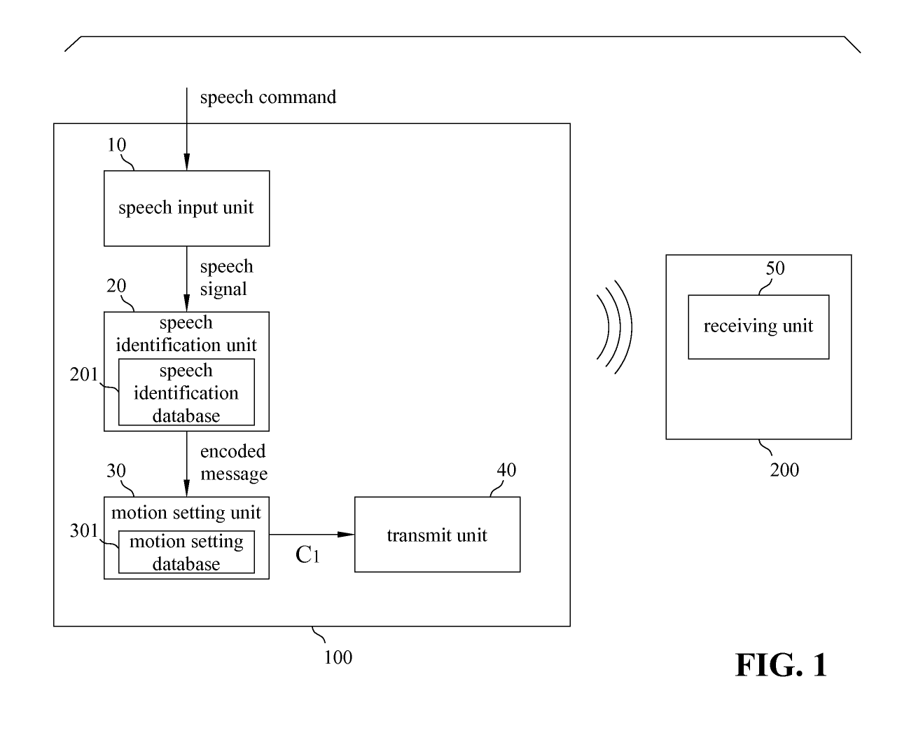

Please refer to FIG. 1, illustrating a functional block diagram of the speech remote control device according to the first embodiment of the present invention. As shown in FIG. 1, the speech remote control device 100 is used for controlling a remote control car 200, and comprises s a speech input unit 10, a speech identification unit 20, a motion setting unit 30, a transmit unit 40 and a receiving unit 50.

Specifically, the speech input unit 10, the speech identification unit 20, the motion setting unit 30 and the transmit unit 40 are provided in the speech remote control device 100 while the receiving unit 50 is provided in the remote control car 200.

More specifically, the speech input unit 10 receives a speech command, converts the speech command into a speech signal, and transfers the speech signal. The speech input unit 10 can be implemented by a microphone or other suitable sound receiver.

The speech identification unit 20 is connected to the speech input unit 10 for receiving the speech signal from the speech input unit 10, generating an encoded message corresponding to the speech signal, and transmitting the encoded message. The speech identification unit 20 is built-in with a programmable and rewritable speech identification database 201, which may comprise a plurality of encoded messages. The encoded messages are preset is such a manner to correspond with the plurality of speech signals, respectively. Only when one of the speech messages preset in the speech identification database 201 is identified by the speech identification unit 20, the according encoded message is generated and transmitted. The speech identification unit 20 may comprise a speech identification chip.

The motion setting unit 30 is connected to the speech identification unit 20 for receiving the encoded message from the speech identification unit 20, decoding the encoded message into a control message, and transmitting the control message. The motion setting unit 30 is built-in with a programmable and rewritable motion setting database 301, which comprises a plurality of control messages. The control messages are preset in such a manner to correspond with the plurality of encoded messages, respectively. More specifically, the control message at least comprises a proceeding command.

The transmit unit 40 is connected to the motion setting unit 30 for receiving the proceeding command C1, and transmitting the received proceeding command C1. The receiving unit 50 receives the proceeding command C1 to drive the remote control car 200 to execute the proceeding command C1 and perform a corresponding proceeding motion or a task. The proceeding motion may comprise a continuous proceeding motion or a stream of proceeding motions formed of a plurality of continuous proceeding motions.

For the present embodiment, it is preferred that the transmit unit 40 comprises a radio frequency transmit circuit, and the receiving unit 50 comprises a radio frequency receive circuit.

Therefore, the user can directly give the speech command like talking to the speech remote control device 100 off the present invention so as to cause the remote control car 200 to perform one continuous proceeding motion or a stream of continuous proceeding motions. The above speech command preferably comprises ‘forward’, ‘backward’, ‘turning’, ‘turning around’, ‘quick forward and backward’, ‘drifting’, ‘S turning’ and so on. The stream of continuous proceeding motions may comprise ‘quick forward and backward’, ‘drifting’, ‘S turning’ and so on.

To cause the remote control car 200 to perform the ‘quick forward and backward’ motion, before giving the speech command like ‘quick forward and backward’, the user needs to preset the speech signal in the speech identification database 201 corresponding to the speech command ‘quick forward and backward’. For the convenience of describing the present embodiment, please refer to Table 1, the speech signal corresponding to the speech command ‘quick forward and backward’ is specified by the speech signal S1, and the encoded message E1 is subsequently preset for the speech signal S1.

TABLE 1

| Speech | speech | encoded | control |
|---|---|---|---|
| command | signal | message | message |
| quick forward and | S1 | E1 | R1 |
| backward | | | |

Here, the control message R1 corresponding to the encoded message E1 is preset in the motion setting database 301, and the motion command of the control message R1 is specified to cause the motor to a fast forward rotation for a period of time, then stop, and fast backward rotation for another period of time.

In the actual operation, the user needs to give the speech command ‘quick forward and backward’ to the speech input unit 10 such that the speech input unit 10 converts the speech command ‘quick forward and backward’ into the speech signal S1, which is transferred to the speech identification unit 20. The speech identification unit 20 performs speech identification, determines if the speech signal S1 is preset in the speech identification database 201, and further determines if the encoded message E1 corresponds to the speech signal S1. If yes, the encoded message E1 is transferred to the motion setting unit 30, which generates the control message R1 based on the encoded message E1, and transfers the control message R1 to the transmit unit 40. The transmit unit 40 further transmits the control message R1 to the receiving unit 50, which executes the control message R1 to cause the remote control car 200 to perform the ‘quick forward and backward’ motion.

The receiving unit 50 may comprise a control chip (not shown) connected to the motor driving device and the turning system (not shown) provided in the remote control car so as to control the rotation status of the motor and the turning function of the turning system.

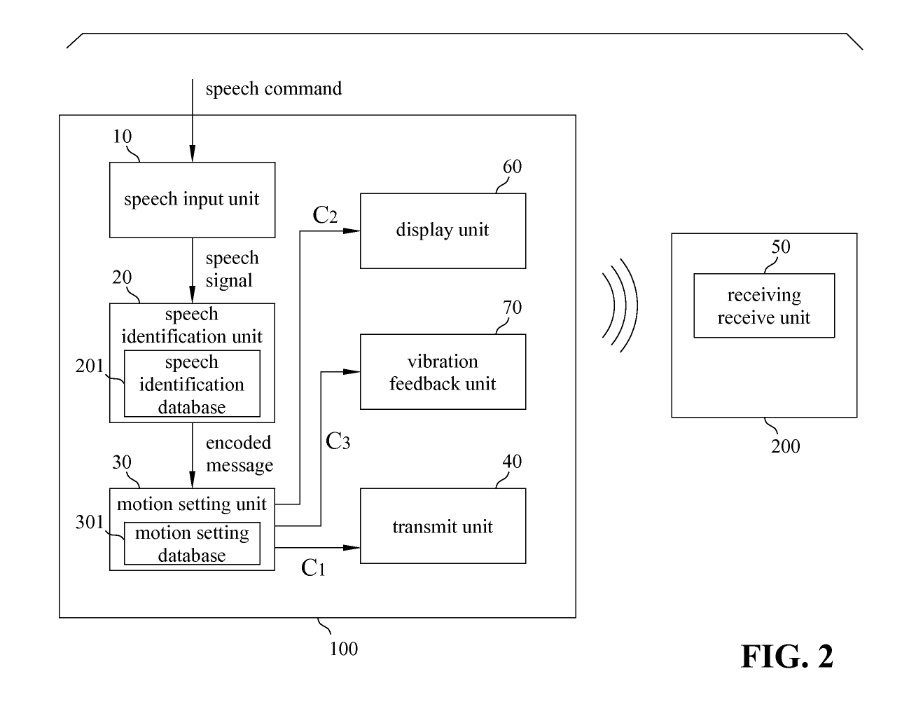

Further refer to FIG. 2 showing the functional block diagram of the speech remote control device according to the second embodiment of the present invention. As shown in FIG. 2, the second embodiment of the present invention further comprises a display unit 60, which is provided in the speech remote control device 100 and connected to the motion setting unit 30. Here, the control message further comprises a display command C2, and the motion setting unit 30 transfers the display command C2 to the display unit 60 so as to display music or generate a specific sound effect.

Furthermore, in the motion setting database 301, the user may preset the control messages corresponding to the encoded messages, respectively, and the control message at least comprises one proceeding command C1. Thus, when the user wants the remote control car 200 to perform the ‘quick forward and backward’ motion and at the same time needs the speech remote control device 100 to display music, the control message only needs to include the display command C2 in addition to the original proceeding command C1. Since the display unit 60 is connected to motion setting unit 30, the display command C2 is transferred to the display unit 60 so as to cause the display unit 60 to execute the function of displaying music or sound effect.

Additionally, the display unit 60 is built-in with a music database comprising pieces of music or sound effect, and each control message includes a specific display command. It is preferred that various specific display commands correspond to the pieces of music or sound effect, respectively.

Therefore, the display unit 60 may display the corresponding music or sound effect based on the specific display command C2, and when the user gives the speech command to the remote control car 200, the speech remote control device 100 of the present embodiment can display the specific music or sound effect for the present proceeding motion.

In other words, when the remote control car 200 performs one proceeding motion, the speech remote control device 100 can display music or sound effect by itself For example, before the control process, the user can preset the piece of music ‘go! Go! Go!’ displayed by the pop singer Wo-bai in the display unit 60, and this music ‘go! Go! Go!’ is specified for the display command corresponding to the speech command “quick forward and backward” such that the speech remote control device 100 displays the music ‘go! Go! Go!’ when the remote control car 200 performs the “quick forward and backward” motion.

As shown in FIG. 2, the speech remote control device of the present embodiment further comprises a vibration feedback unit 70, which is provided in the speech remote control device 100 and connected to the motion setting unit 30. The control message may further comprise a vibration generation command C3, and the motion setting unit 30 transfers the vibration generation command C3 to the vibration feedback unit 70 so as to perform a vibration effect. Preferably, the vibration feedback unit 70 is a vibration generation device.

If the user wants to invoke some specific proceeding motion and display the music and vibration effect at the same time, it simply needs to build up the vibration generation command C3 in the control message in addition to the proceeding command C1 and the display command C2 such that the vibration generation command C3 is transferred to the vibration feedback unit 70 from the motion setting unit 30 and the vibration feedback unit 70 is driven to generate the vibration effect as desired. Preferably, the vibration effect is continuously or intermittently generated.

From the above detailed description, one aspect of the present invention is that the user only needs to give the speech command so as to remote manipulate the remote control car to perform the proceeding motion corresponding to the speech command. In comparison with the hand control design the prior arts, the time taken by pulling the control joystick/bar and triggering the control signal is thus saved, and the remote control car can immediately perform the desire motion right after the user sends the speech command, thereby fulfilling the object of real time control.

In the motion setting database, the user may preset the proceeding command for the encoded message. For example, the proceeding command is encoded as one continuous proceeding motion or one stream of proceeding motions formed of a plurality of continuous proceeding motions.

As for the S turn motion, the motor needs to keep rotating, and the turning system first turns right to some suitable content, then gradually returns back to the reference position, turns left to some suitable content, and finally gradually returns back to the designated position.

From the above mentioned, the S turn motion primarily consists of four processes such that the proceeding command is encoded into four instruction codes based on the order of the four processes. The transmit unit sequentially transmits the four encoded codes to the receiving unit, and the turning system of the remote control car can sequentially execute the four encoded codes to perform the desired continuous proceeding motions, which implements the S turn motion. Certainly, to keep the motor constantly rotating, the proceeding command may further comprise a forward rotation command to actuate the motor.

Another aspect of the present invention is that the user only needs to send the speech command (like S turn) one time, the remote control car can perform one complex continuous proceeding motion or one stream of complex continuous proceeding motions. Since the motion setting unit and other related units automatically transfer the signal and perform the control function, the remote control car successfully performs real time action in response of the command from the user so as to achieve that the remote control car performs one continuous proceeding motion or one stream of continuous proceeding motions. Therefore, the control effect becomes versatile and the preciseness of remote control is enhanced such that the function and application field of the remote control car are greatly expanded, and the present invention is used to transport the stuff, and even applicable to the remote device for handling explosive. The present invention further provides the function of displaying music and generating the vibration feedback so as to enhance the entertaining effect for the user.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A speech remote control device for controlling a remote control car, comprising:
a speech input unit provided in the speech remote control device for receiving a speech command, converting the speech command into a speech signal, and transferring the speech signal;
a speech identification unit provided in the speech remote control device and connected to the speech input unit for receiving the speech signal, generating and transmitting an encoded message corresponding to the speech signal, wherein the speech identification unit comprises a built-in programmable and rewritable speech identification database, which has a plurality of encoded messages preset and corresponding to the plurality of speech signals, respectively, and when the speech identification unit identifies one of the speech messages preset in the speech identification database, the encoded message according to the speech signal is generated and transmitted;
a motion setting unit provided in the speech remote control device and connected to the speech identification unit for receiving the encoded message, decoding the encoded message into a control message, and transmitting the control message, wherein the motion setting unit comprises a built-in programmable and rewritable motion setting database, which has a plurality of control messages preset and corresponding to the plurality of encoded messages, respectively, and the control message having at least a proceeding command;
a transmit unit provided in the speech remote control device and connected to the motion setting unit for receiving the proceeding command, and transmitting the received proceeding command; and
a receiving unit provided in the remote control car for receiving the proceeding command to drive the remote control car to execute the proceeding command and perform a corresponding proceeding motion.

2. The speech remote control device as claimed in claim 1, wherein the speech input unit is a microphone.

3. The speech remote control device as claimed in claim 1, wherein the speech identification unit comprises a speech identification chip.

4. The speech remote control device as claimed in claim 1, wherein the transmit unit comprises a radio frequency transmit circuit, and the receiving unit comprises a radio frequency receive circuit.

5. The speech remote control device as claimed in claim 1, wherein the proceeding motion comprises a continuous proceeding motion or a stream of proceeding motions formed of a plurality of continuous proceeding motions.

6. The speech remote control device as claimed in claim 1, further comprising a display unit provided in the speech remote control device and connected to the motion setting unit, wherein the control message further comprises a display command, the motion setting unit transfers the display command to the display unit so as to display music or generate a sound effect.

7. The speech remote control device as claimed in claim 1, further comprising a vibration feedback unit provided in the speech remote control device and connected to the motion setting unit, wherein the control message further comprises a vibration generation command, the motion setting unit transfers the vibration generation command to the vibration feedback unit so as to perform a vibration effect.

8. The speech remote control device as claimed in claim 6, further comprising a vibration feedback unit provided in the speech remote control device and connected to the motion setting unit, wherein the control message further comprises a vibration generation command, the motion setting unit transfers the vibration generation command to the vibration feedback unit so as to perform a vibration effect.

9. The speech remote control device as claimed in claim 7, wherein the vibration feedback unit is a vibration generation device.

10. The speech remote control device as claimed in claim 8, wherein the vibration feedback unit is a vibration generation device.
